(19) United States
(12) Patent Application Publication
(10) Pub. No.: US 2025/0280024 A1
(43) Pub. Date: Sep. 4, 2025

(54) DEVICE AND METHOD OF DETERMINING MALICIOUS PACKET IN ENCRYPTED TRAFFIC BASED ON ARTIFICIAL INTELLIGENCE

(71) Applicant: SECURELINK CO., LTD, Seoul (KR)

(72) Inventors: Junyong KO, Gyeonggi-do (KR); Jusun PARK, Seoul (KR)

(21) Appl. No.: 19/208,601

(22) Filed: May 15, 2025

Related U.S. Application Data
(63) Continuation-in-part of application No. PCT/KR2023/016663, filed on Oct. 25, 2023.

(30) Foreign Application Priority Data
Nov. 15, 2022 (KR) 10-2022-0152398

(51) Int. Cl. H04L 9/40; H04L 41/16

(52) U.S. Cl. CPC H04L 63/1425; H04L 41/16; H04L 63/1466

(57) ABSTRACT

Disclosed is a method for detecting and classifying network encryption threats based on artificial intelligence performed by a computing device. The disclosed method for detecting and classifying network encryption threats based on artificial intelligence performed by a computing device may comprise: selecting a packet corresponding to an encryption protocol by analyzing a protocol of a packet incoming from an external network; extracting a fingerprint characteristic for the selected packet; generating a meta characteristic based on the fingerprint characteristic; determining maliciousness by inputting the fingerprint characteristic and the meta characteristic into a first artificial intelligence model; generating a visualized graph by embedding the packet determined to be malicious by the first first artificial model together with one of predefined multiple characteristics; and performing threat classification and attack type prediction by inputting the visualized graph into a pre-trained second artificial intelligence model.

### CROSS-REFERENCE TO RELATED APPLICATION

This application is a US Bypass Continuation-in-Part Application of International Application No. PCT/KR2023/016663, filed on Oct. 25, 2023, which claims priority to and the benefit of Korean Patent Application No. 10-2022-0152398, filed on Nov. 15, 2022, the disclosure of which is incorporated herein by reference in its entirety.

### BACKGROUND

### Technical Field

The present invention relates to a device and method for determining whether an encrypted traffic contains malicious packets based on artificial intelligence, and more specifically, to a device and method for determining whether network traffic contains malicious packets by utilizing high-dimensional characteristics of a network.

### Background Art

As announced by professional organizations that ransomware attacks occur approximately once every two seconds on average worldwide, attacks on social public facilities and supply chains using major ransomware have recently increased. In the United States and Canada, for example, oil supply chains have been attacked, causing significant damage to numerous companies, facilities, and the daily lives of ordinary people.

In addition, the combination of ransomware and APT hacking techniques has resulted in greater damage. For instance, in domestic defense industry-related research institutes and technology companies, critical weapon system information has been leaked, and privacy violations have increased due to the hacking of apartment wall pads integrated with smart city technology.

Moreover, as hacking methods and technologies targeting almost all fields, including hospitals, companies' critical information, and individuals' personal information, as well as public networks and social facilities, become more sophisticated and advanced, technologies to block such threats at endpoints (PCs and devices) are being developed. These include network detection technologies (NDR), IPS, and next-generation UTM, which are being integrated with artificial intelligence technologies to detect malicious codes embedded in network packets themselves.

However, an increasing number of malicious codes are being transmitted through secure channels such as SSL/TLS. Consequently, the malicious codes targeted for detection by technologies like artificial intelligence are often encrypted during transmission. Statistically, there was an increase of over 260% in 2017 compared to 2016.

In particular, hackers are exploiting SSL/TLS encrypted traffic, a secure channel technology developed to protect packet information transmitted over networks. This makes it difficult to detect and block malicious traffic in the network flow state before decryption at the endpoint or network receiver. Therefore, there is a need to develop technology capable of detecting malicious traffic without SSL/TLS decryption.

In other words, the commercialization of technology capable of detecting malicious traffic without SSL/TLS decryption can enable the rapid detection and preemptive blocking of malicious traffic before it reaches the endpoints of enterprises, governments, or individuals. It also enhances the possibility of precise analysis and tracking, and through integration with NDR, XDR, EDR, and endpoint security platforms (EPP) such as antivirus software, it can effectively and comprehensively block malicious codes.

### SUMMARY

The technical problem to be solved by the present invention is to overcome the limitations of applying artificial intelligence detection technology or various malware detection technologies after visualizing (decrypting) encrypted traffic, in a situation where various new/variant malware such as rapidly increasing malicious code and ransomware are being transmitted and spread through network security channels such as SSL/TLS encrypted traffic.

The objective is to detect whether malicious traffic packets are included quickly and effectively by extracting high-dimensional characteristics of continuous traffic without decrypting the network encrypted traffic.

Additionally, the technical problem to be solved by the present invention is to classify detected threats quickly through a graph-based artificial intelligence model robust to various modified attacks, compare them with pre-learned attack type data to predict subsequent attacks, and respond effectively.

The problems to be solved by the present invention are not limited to the aforementioned problems, and other problems not mentioned will be clearly understood by those skilled in the art from the following description.

According to embodiments of the present invention for achieving the above-described objectives, a method for detecting and classifying network encryption threats based on artificial intelligence performed by a computing device may comprise: analyzing the protocol of a packet incoming from an external network to select a packet corresponding to an encryption protocol; extracting fingerprint characteristics for the selected packet; generating meta characteristics based on the fingerprint characteristics; determining maliciousness by inputting the fingerprint characteristics and meta characteristics into a first artificial intelligence model; generating a visualized graph by embedding one of predefined multiple characteristics together for a packet determined to be malicious by the first artificial intelligence model; and performing threat classification and attack type prediction by inputting the visualized graph to a pre-trained second artificial intelligence model.

In one embodiment, the predefined multiple characteristics may comprise: a first characteristic indicating transaction information of a packet corresponding to the encryption protocol; a second characteristic indicating session information to which a packet corresponding to the encryption protocol is transmitted or received; and a third characteristic indicating IP information to which a packet corresponding to the encryption protocol is transmitted.

In one embodiment, the visualized graph associated with the first characteristic may comprise a first graph indicating a packet determined to be malicious as one point based on a class of the transaction information; the visualized graph associated with the second characteristic may comprise a second graph representing each session as a point having visually different characteristics according to a data type corresponding to each session; and the visualized graph associated with the third characteristic may comprise a third graph displaying an IP address corresponding to each IP information as one point, and displaying a connection state of points corresponding to each based on a connection state between IP addresses.

In one embodiment, the step of performing threat classification and attack type prediction may comprise: performing clustering for at least one point included in the visualized graph; determining a representative instance for each cluster based on the clustering result; and determining an attack type for the cluster based on an attack campaign corresponding to the representative instance.

In one embodiment, the step of determining an attack type may further comprise: predicting a potential attack based on the determined attack type; and generating a signal to block the predicted potential attack.

According to embodiments of the present invention for achieving the above-described objectives, a computing device for determining whether malicious packets are included in encrypted traffic based on artificial intelligence may comprise at least one processor.

In one embodiment, the processor may comprise: a feature extraction unit for extracting predefined packets and multiple fingerprint characteristic (fingerprints) from network encrypted traffic incoming to the computing device; a meta-characteristic generation unit for generating meta-characteristics for the network traffic by tracking changes over time of at least one parameter included in the extracted packets using the packets and multiple fingerprint characteristic extracted by the feature extraction unit; and a determination unit for determining whether malicious packets are included in the network traffic by inputting the multiple fingerprint characteristic and the meta-characteristics into a pre-trained artificial neural network.

In one embodiment, the feature extraction unit may extract at least some of the encryption channel protocol, encryption channel certificate, source address, destination address, port information, and header information from the unencrypted area of the network encrypted traffic or in an encrypted state as the multiple fingerprint characteristic.

In one embodiment, the meta-characteristic generation unit may group multiple packets executing one session from a pre-stored session list as one group and generate changes in parameters associated with packets accumulated in each group over time as the meta-characteristics.

In one embodiment, the meta-characteristic generation unit may allocate the packet to at least one of predefined groups depending on whether the same packet or the same session exists for the packet included in the new network traffic when packets and multiple fingerprint characteristic for new network encrypted traffic are delivered from the feature extraction unit.

In one embodiment, the meta-characteristic generation unit may use at least one of the total network arrival time of the packet, network latency, transmission and reception patterns of the network traffic including the packet, BPS (Bit per second), PPS (Packet per second), connection time between packets, the number of sessions per unit time, the number of users per unit time, and the estimated purpose hit of the packet as parameters associated with the packet.

In one embodiment, the determination unit may asynchronously update packets or multiple fingerprint characteristic associated with the first network encrypted traffic to a packet classification filter for malicious packets when it is determined that malicious packets are included in the first network encrypted traffic, and may perform blocking for the second network traffic through the packet classification filter when packets and multiple fingerprint characteristic (fingerprints) for the second network traffic are delivered from the feature extraction unit.

In one embodiment, a method for determining whether malicious packets are included based on artificial intelligence performed by a computing device may comprise: extracting predefined packets and multiple fingerprint characteristic (fingerprints) from network encrypted traffic; generating meta-characteristics for the network traffic by tracking changes over time of at least one parameter included in the extracted packets using the extracted packets and multiple fingerprint characteristic; and determining whether malicious packets are included in the network encrypted traffic by inputting the multiple fingerprint characteristic and the meta-characteristics into a pre-trained artificial neural network.

In one embodiment, the step of extracting predefined packets and multiple fingerprint characteristic (fingerprints) may be performed by extracting them from the unencrypted area of the network traffic or in an encrypted state.

The encrypted channel protocol, encrypted channel certificate, source address, destination address, port information, and header information, at least some of which are extracted in an encrypted state, may be extracted as the plurality of fingerprint characteristic.

According to one embodiment, the step of generating the meta characteristic may comprise grouping a plurality of packets executing one session among pre-stored session lists as one group, and generating changes in parameters associated with packets accumulated in each group over time as the meta characteristic.

According to one embodiment, the step of generating the meta characteristic may further comprise, when packets and a plurality of fingerprint characteristic for new network traffic are delivered from the characteristic extraction unit, assigning the packet to at least one of pre-designated groups depending on whether the same packet or the same session for the packet included in the new network traffic exists in a pre-designated memory area.

According to one embodiment, the parameters associated with the packet may comprise at least one of the total network arrival time of the packet, network latency, transmission and reception patterns of the network traffic including the packet, BPS (Bit per second), PPS (Packet per second), connection time between packets, the number of sessions per unit time, the number of users per unit time, and the destination hit estimation of the packet.

According to one embodiment, the step of determining whether the network encrypted traffic includes a malicious packet may comprise, if it is determined that the first network encrypted traffic includes a malicious packet, asynchronously updating the packet or the plurality of fingerprint characteristic associated with the first network traffic to a packet classification filter for the malicious packet, and further performing a step of determining whether to block the second network encrypted traffic through the packet classification filter when the packet and the plurality of fingerprint characteristic (fingerprint) for the second network encrypted traffic are delivered from the characteristic extraction unit.

According to the embodiments of the present invention, it is possible to rapidly detect malicious packets containing malicious codes, ransomware, and various mutated malicious codes that are being distributed within the explosively increasing encrypted traffic on secure channels, without requiring complex configurations of resources and infrastructure for decrypting packets within the traffic.

In addition, the present invention enables the rapid detection of encryption threats and the classification of threats to identify attackers related to the threats, and by comparing the attack types corresponding to the threats, it is possible to predict and block in advance the types of attacks that may occur consecutively.

Furthermore, even in the configuration of converged security models such as EDR and NDR, it is possible to quickly specify in advance the scope and targets that need to be detected and blocked, enabling a more accurate and selective concentration of resources for a robust response.

Additionally, it is possible to predict endpoint (PC, mobile devices, etc.) and cloud attack techniques for attackers and attacks that are likely to occur consecutively, and respond in advance, thereby drastically reducing the time and resources required for decrypting encrypted packets and verifying and responding through them.

Through the present invention, it is possible to complement the vulnerable security environments of small and medium-sized enterprises, small business owners, and individual users who are exposed to the majority of damages caused by malicious codes such as ransomware, and to provide the effect of detecting and blocking malicious codes in advance at the network level without significant financial investment.

Moreover, even in the configuration of converged security models such as EDR and NDR, it is possible to quickly and preemptively specify and reduce the scope and targets that need to be detected and blocked, enabling a more accurate and selective concentration of resources for a robust response.

Additionally, in the domestic firewall and network market, which is worth approximately 200 billion KRW, the present invention can significantly contribute to cost reduction and the expansion of new technologies through innovations in the firewall and UTM market, which serve as critical security measures for small and medium-sized enterprises.

### BRIEF DESCRIPTION OF THE DRAWINGS

FIG. 1 is a block diagram of a computing device performing a method for determining whether a malicious packet is included according to an embodiment.

FIG. 2 is an exemplary diagram for explaining encryption traffic fingerprints and meta characteristics according to an embodiment.

FIG. 3 is an exemplary diagram for explaining an operation of detecting malicious encryption traffic according to an embodiment.

FIG. 4 is an exemplary diagram for explaining an operation interworking with an endpoint terminal device according to an embodiment.

FIG. 5 is an exemplary diagram for explaining an operation interworking with cloud equipment according to an embodiment.

FIG. 6 is a flowchart for explaining a method for determining whether a malicious packet is included according to an embodiment.

FIG. 7 is a flowchart for explaining a method for determining whether a malicious packet is included by interworking with an endpoint terminal device according to an embodiment.

FIG. 8 is a flowchart for explaining a method for determining whether a malicious packet is included by interworking with cloud equipment according to an embodiment.

FIG. 9 is a block diagram for explaining an artificial intelligence-based network encryption threat detection and classification device according to another embodiment.

FIG. 10 is a flowchart for explaining an artificial intelligence-based network encryption threat detection and classification method according to another embodiment.

FIGS. 11A to 11C are exemplary diagrams for explaining graphs generated based on characteristics according to an embodiment.

FIG. 12 is a flowchart for explaining an operation of detecting a malicious attachment file included in an encryption threat according to an embodiment of the present invention.

FIG. 13 is a flowchart for explaining an operation of interworking an artificial intelligence-based network encryption threat detection and classification device with an endpoint according to an embodiment of the present invention.

FIG. 14 is a flowchart for explaining an operation of interworking an artificial intelligence-based network encryption threat detection and classification device with a cloud according to an embodiment of the present invention.

FIG. 15 is a flowchart for explaining an operation of detecting, classifying, and predicting encryption threats according to an embodiment of the present invention.

FIG. 16 is a flowchart for explaining an operation of detecting encryption threats according to an embodiment of the present invention.

### DETAILED DESCRIPTION

Hereinafter, embodiments of the present invention will be described in detail with reference to the accompanying drawings.

The embodiments of the present invention described below are provided to make the present invention more clearly understood by those skilled in the art, and the scope of the present invention is not limited by the following embodiments, which may be modified in various other forms.

The terms used in this specification are used to describe specific embodiments and are not intended to limit the present invention. The singular forms of terms used in this specification may include plural forms unless the context clearly indicates otherwise. In addition, the terms “comprise” and/or “comprising” as used in this specification specify the presence of stated shapes, steps, numbers, operations, members, elements, and/or groups thereof, but do not exclude the presence or addition of one or more other shapes, steps, numbers, operations, members, elements, and/or groups thereof. Furthermore, the term “connection” as used in this specification includes not only direct connections between members but also indirect connections where other members are interposed between the members.

Moreover, when a member is described as being “on” another member in this specification, it includes not only cases where the member is in contact with the other member but also cases where another member exists between the two members. The term “and/or” as used in this specification includes any one and all combinations of the listed items. Additionally, terms such as “about” and “substantially” used in this specification are used to encompass the range or approximate meaning of the numerical value or degree, considering inherent manufacturing and material tolerances, and to prevent an infringer from unfairly exploiting the disclosed content provided for understanding the present invention.

Hereinafter, embodiments of the present invention will be described in detail with reference to the accompanying drawings. The sizes or thicknesses of areas or parts shown in the accompanying drawings may be somewhat exaggerated for clarity and convenience of explanation in the specification. Throughout the detailed description, the same reference numerals denote the same components.

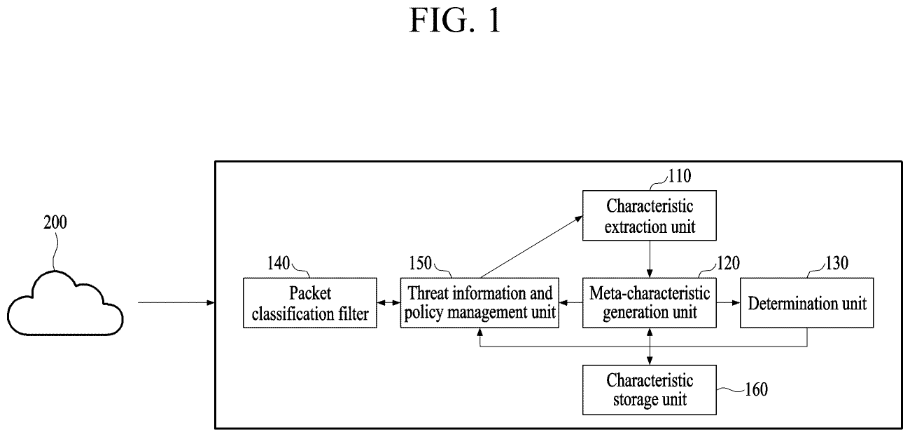

FIG. 1 is a block diagram of a computing device that performs a method for determining whether a malicious packet is included according to an embodiment.

Referring to FIG. 1, the computing device that determines whether a malicious packet is included based on artificial intelligence may comprise at least one processor 100.

According to one embodiment, the processor 100 may implement a characteristic extraction unit 110, a meta-characteristic generation unit 120, and a determination unit 130.

According to one embodiment, the characteristic extraction unit 110 may extract pre-designated packets and multiple fingerprint characteristic from network encryption traffic incoming to the computing device. The characteristic extraction unit 110 may extract at least some of the encryption channel protocol, encryption channel certificate, source address, destination address, port information, and header information, which are extracted from the unencrypted area of the network traffic or in an encrypted state, as the multiple fingerprint characteristic. The characteristic extraction unit 110 may extract the fingerprint characteristic from the unencrypted area of the network traffic, enabling the extraction of fingerprint characteristic without a decryption process.

According to one embodiment, the characteristic extraction unit 110 may extract fingerprint characteristic without a decryption process, enabling rapid detection of packets containing malicious code, ransomware, and each variant of malicious code traffic without requiring complex configurations of resources and infrastructure for decryption. That is, the computing device according to the present invention can complement the vulnerable security environments of small and medium-sized enterprises, small business owners, and individual users exposed to damage from malicious code such as ransomware, and provide the effect of pre-detecting and blocking malicious code at the network level without significant cost investment. Accordingly, in constructing converged security models such as EDR and NDR, it is possible to quickly specify and reduce the scope and targets to be detected and blocked in advance, enabling more accurate and selective resource concentration for a strong response.

According to one embodiment, the meta-characteristic generation unit 120 may generate meta-characteristics for the network traffic by tracking the changes over time of at least one parameter included in the extracted packet using the packet and multiple fingerprint characteristic extracted by the characteristic extraction unit 110. That is, the meta-characteristic generation unit 120 may query preceding packets within the same session or traffic to generate high-dimensional meta-characteristics for the packet delivered from the characteristic extraction unit 110.

According to one embodiment, the meta-characteristic generation unit 120 may group multiple packets executing one session among pre-stored session lists as one group and generate the changes in parameters associated with packets accumulated in each group over time as the meta-characteristics.

According to one embodiment, the meta-characteristic generation unit 120 may allocate the packet to at least one of pre-designated groups depending on whether the same packet or the same session exists for the packet included in the new network traffic when the packet and multiple fingerprint characteristic for the new network traffic are delivered from the characteristic extraction unit.

According to one embodiment, the meta-characteristic generation unit 120 may use at least one of the total network arrival time of the packet, network latency, transmission and reception patterns of the network traffic containing the packet, BPS (Bit per second), PPS (Packet per second), connection time between packets, the number of sessions per unit time, the number of users per unit time, and the estimated destination hit of the packet as parameters associated with the packet.

According to one embodiment, the determination unit 130 may determine whether the network traffic includes malicious packets by inputting the multiple fingerprint characteristic and the meta-characteristics into a pre-trained artificial neural network. That is, the determination unit 130 may receive a request for determining maliciousness from the meta-characteristic generation unit 120.

According to one embodiment, the determination unit 130 may determine maliciousness based on the requested characteristics by combining and learning fingerprints and meta-characteristics based on large-scale data classification models and deep learning models such as RNN and CNN, and provide the determination result to the threat information and policy management unit 150.

According to one embodiment, the determination unit 130 may asynchronously update the packet or multiple fingerprint characteristic associated with the first network traffic to the packet classification filter 140 for malicious code when it is determined that the first network encryption traffic includes malicious packets. The determination unit 130 may perform blocking for the second network encryption traffic through the packet classification filter 140 when the packet and multiple fingerprint characteristic for the second network encryption traffic are delivered from the characteristic extraction unit.

According to one embodiment, the packet classification filter 140 may separate the protocol of the packet for network encryption traffic packets incoming from external networks such as WAN or other networks and classify and store packets corresponding to the secure channel for future use.

According to one embodiment, when the determination unit 130 determines that the first network traffic includes a malicious packet, the packet classification filter 140 may asynchronously update the packet or multiple fingerprint characteristic associated with the first network encryption traffic. Additionally, when the determination unit 130 delivers the packet and multiple fingerprint characteristic (fingerprint) for the second network encryption traffic from the characteristic extraction unit, the packet classification filter 140 may perform blocking for the second network encryption traffic.

According to one embodiment, the threat information and policy management unit 150 may request artificial intelligence determination for the relevant packet, reply regarding the maliciousness of the previously determined packet, and provide the reply result to other security equipment.

According to one embodiment, the characteristic storage unit 160 may store the relevant packet information to extract additional high-dimensional characteristics if there is no stored preceding packet information.

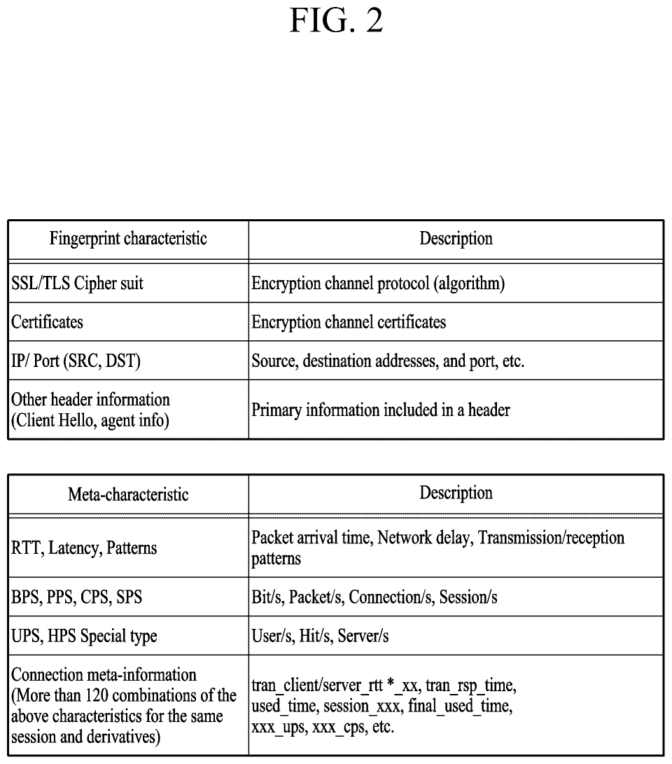

FIG. 2 is an exemplary diagram for explaining encryption traffic fingerprints and meta characteristics according to one embodiment.

Referring to FIG. 2, information on each fingerprint characteristic value and meta characteristic can be identified. For example, SSL/TLS Cipher suite may indicate an encryption channel protocol (algorithm). Certificates may indicate encryption channel certificates. IP/Port (SRC, DST) may indicate source, destination addresses, and ports. Other header information such as Client Hello and agent info may indicate primary information included in the header.

According to one embodiment, meta characteristics such as RTT may indicate packet arrival time, Latency may indicate network delay, and Pattern may indicate transmission and reception patterns. BPS may indicate Bit per second, PPS may indicate Packet per second, CPS may indicate connection time between packets, SPS may indicate the number of sessions per unit time, UPS may indicate the number of users per unit time, and HPS may indicate the estimated hit of the packet's destination. Additionally, connection meta information may include tran_client/server_rtt *_ xx, tran_rsp_time, used_time, session_xxx, final_used_time, xxx_ups, xxx_cps, etc.

That is, the meta characteristic generation unit 120 may select characteristics such as RTT (total network arrival time of the relevant packet), network delay time (Latency), transmission and reception patterns of the traffic containing the relevant packet, BPS (Bit/s), PPS (Packet/s), connection time between packets (Connection/s), sessions (Sessions/s), user information (User/s) that can be estimated and extracted through associated information between traffic packet fingerprint information and response packets, and the estimated hit rate of the packet's destination (Hits/s). The meta characteristic generation unit 120 may generate various final meta characteristics by cross-combining the generated characteristics with source and destination information.

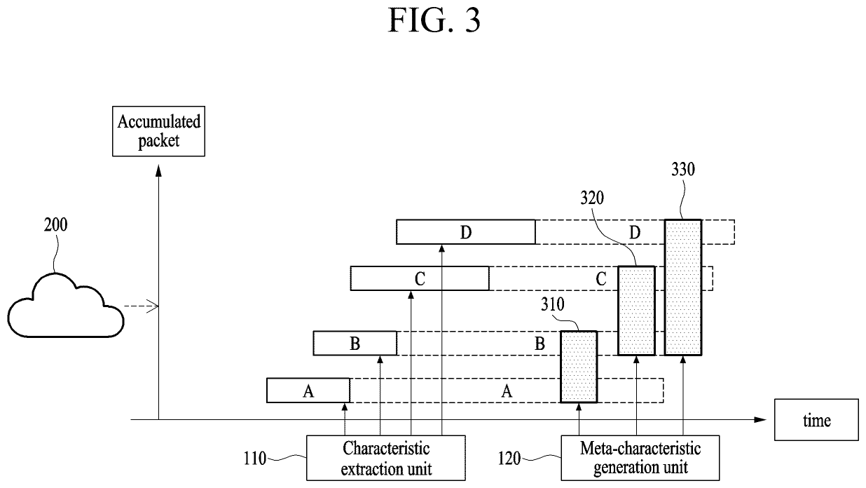

FIG. 3 is an exemplary diagram for explaining the operation of detecting malicious encryption traffic according to one embodiment.

Referring to FIG. 3, the characteristic extraction unit 110 may define fingerprint characteristics in advance (A, B, C, D) and individually extract fingerprint characteristic for each requested packet accordingly. After the characteristic extraction unit 110 extracts the fingerprint characteristic, it may deliver the characteristics along with the packet information to the meta characteristic generation unit 120 to generate more advanced meta characteristics.

The meta characteristic generation unit 120 may group multiple packets executing one session among the pre-stored session lists as one group and generate changes in parameters associated with packets accumulated over time in each group (310, 320, 330) as the meta characteristics.

The meta characteristic generation unit 120 may allocate the packet to at least one of the pre-designated groups (310, 320, 330) depending on whether the same packet or the same session exists for the packet included in the new network traffic, when the packet and multiple fingerprint characteristic for the new network encryption traffic are delivered from the characteristic extraction unit 110. For example, the first group 310 may be defined as a group including packets executing the first session. The first group 310 may group packet A and packet B performing the first session, and although not shown in FIG. 3, packets performing the first session among subsequently delivered packets may be newly allocated to the first group 310. Similarly, the second group 320 may group packets executing the second session, grouping packet B and packet C. Additionally, the third group 330 may group packets executing the third session, grouping packet B, packet C, and packet D. The meta characteristic generation unit 120 may track changes over time in multiple parameters related to each group (310, 320, 330) and generate them as meta characteristics.

According to one embodiment, the meta characteristic generation unit 120 may query the characteristic storage unit 160 to check whether associated packets stored previously exist based on the requested packet and characteristics.

That is, the meta characteristic generation unit 120 may define meta characteristics in advance and generate individual combinations for packets associated with the requested packet accordingly. If no associated packets or characteristics exist for the relevant packet, it may store the relevant packet and characteristics in the characteristic storage unit 160 and reply to the threat information and policy management unit 150 that additional characteristic information is required for the relevant packet as an undetected result.

According to another embodiment, the characteristic extraction unit 110 may combine related packet information stored in the characteristic storage unit 160 and extract additional time and related advanced characteristics if related packets are stored.

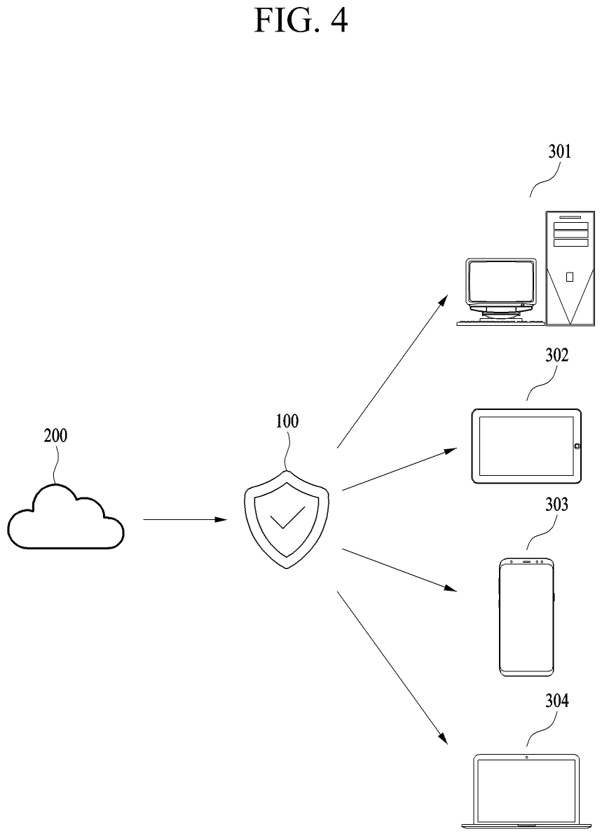

FIG. 4 is an exemplary diagram for explaining the operation interworking with endpoint terminal equipment according to one embodiment.

Referring to FIG. 4, the processor according to the present invention may be mounted on various security equipment and network equipment such as a firewall (FW), UTM, intrusion prevention system (IPS), and next-generation network detection (NDR). At this time, the security management unit operating on various terminal devices such as external PCs, mobile devices, and IoT devices may provide information on whether malicious detection is performed for site access information of users and devices, allowing the security management unit of the relevant device to block access to the relevant site and remote access in advance or block the execution of downloaded files.

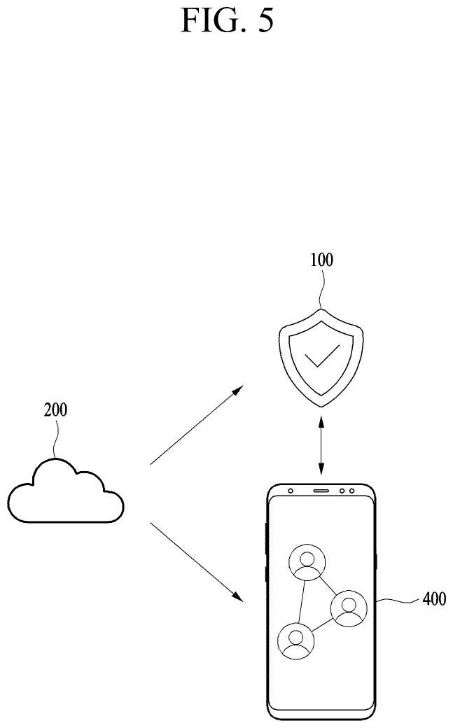

FIG. 5 is an exemplary diagram for explaining the operation interworking with cloud equipment according to one embodiment.

Referring to FIG. 5, the processor according to the present invention may be mounted on various security equipment and network equipment such as a firewall (FW), UTM, intrusion prevention system (IPS), and next-generation network detection (NDR). At this time, it may share packets and learning information with a security management unit built in an external network environment such as an external cloud. This result may be provided again to external threat information sharing (CTI) and cloud software rental system (SaaS) equipment to determine and process the maliciousness of the relevant packet.

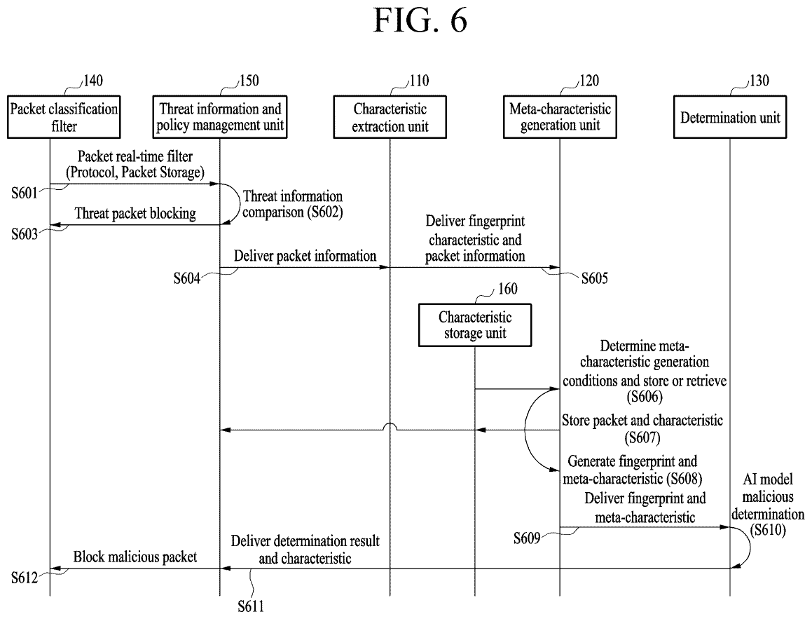

FIG. 6 is a flowchart for explaining a method of determining whether a malicious packet is included according to one embodiment.

Referring to FIG. 6, the packet classification filter 140 may classify protocols from incoming network traffic packets and transmit packets corresponding to the security channel to the threat information and policy management unit 150 (S601). The classified packets may be used for subsequent audits and warning processing and may be stored for asynchronous mirroring configurations depending on the network configuration.

According to one embodiment, the threat information and policy management unit 150 may query whether prior detection results exist for the same packet through the fingerprint information of the requested packet (S602). According to one embodiment, the threat information and policy management unit 150 may reply with the result if such a result exists.

According to one embodiment, the packet classification filter 140 can identify a packet through fingerprint characteristic and block the packet if existing detection determination information is available (S603).

According to one embodiment, the threat information and policy management unit 150 can transmit the packet information to the characteristic extraction unit 110 to extract primary characteristics such as fingerprints if no existing determination information is available (S604).

According to one embodiment, the characteristic extraction unit 110 can transmit the fingerprint characteristic along with the packet information to the meta characteristic generation unit 120 to generate more advanced meta characteristics after extracting the fingerprint characteristic (S605).

According to one embodiment, the meta characteristic generation unit 120 can determine the meta characteristic generation conditions and store or retrieve the meta characteristics accordingly (S606).

According to one embodiment, the meta characteristic generation unit 120 can query the characteristic storage unit 160 to check whether associated packets stored previously exist based on the requested packet and fingerprint characteristic. The meta characteristic generation unit 120 can generate individual combinations for packets associated with the requested packet. If no associated packets or characteristics related to the packet exist, the meta characteristic generation unit 120 can store the packet and characteristics in the characteristic storage unit 160 (S607). If additional characteristic information is required for the packet, the meta characteristic generation unit 120 can return an undetected result to the threat information and policy management unit 150 and terminate the process.

According to one embodiment, if related packets are stored in the characteristic storage unit 160, the characteristic storage unit 160 can combine the related packet information and extract additional advanced characteristics such as time and related characteristics. According to one embodiment, the characteristic storage unit 160 can query the accumulated state of previously stored packets when the meta characteristic generation unit 120 generates meta characteristics. The characteristic storage unit 160 can extract and calculate interrelated information from the accumulated packet information and combine and store advanced characteristics.

According to one embodiment, the determination unit 130 can receive the fingerprint characteristic and the generated meta characteristics (S609). The determination unit 130 can generate and reference classification indicators clustered into a large-scale classification model without labeling based on pre-collected and labeled large-scale general and malicious traffic packet data and fingerprint characteristic. The determination unit 130 can generate determination results of the artificial neural network for the requested characteristics through a deep learning model (RNN, CNN) optimized with various hyperparameters and detailed modules using the fingerprint characteristic and meta characteristics (S610).

According to one embodiment, the determination unit 130 can transmit the output results of the artificial neural network to the threat information and policy management unit 150 (S611). Specifically, the threat information and policy management unit 150 can receive and store the determination results transmitted from the determination unit 130 and configure the information according to a threat information sharing (CTI) protocol, such as STIX format or JSON data format, to provide the information externally.

Finally, the packet classification filter 140 can block the packet based on the determination results of the packet transmitted to the threat information and policy management unit 150 (synchronous) or transmit and store the results in security systems, databases, etc., such as queries and logs, based on the results received for stored packets (asynchronous) (S612).

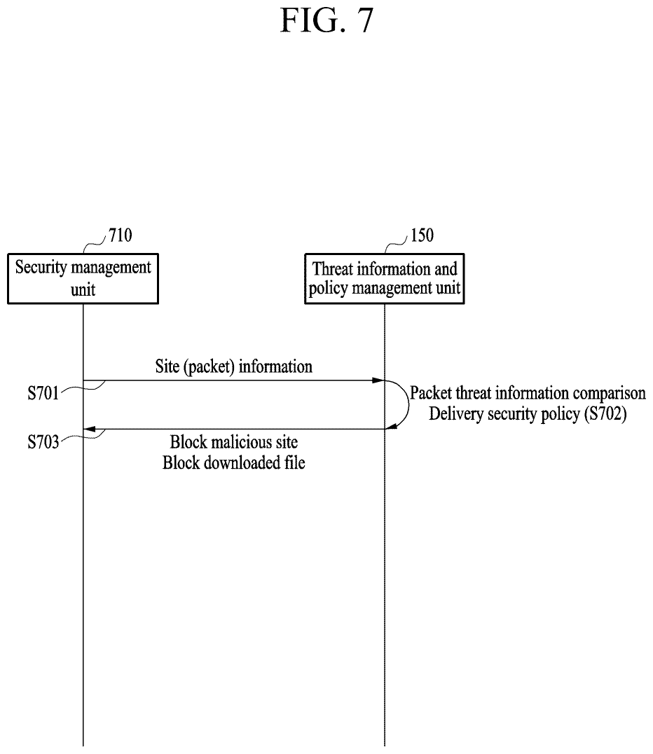

FIG. 7 is a flowchart illustrating a method for determining whether a malicious packet is included in conjunction with an endpoint terminal device according to one embodiment.

Referring to FIG. 7, the security management unit 710 included in the endpoint terminal device can transmit site information packets accessed by the terminal device or packet information containing specific fingerprint characteristics to the threat information and policy management unit 150 (S701).

According to one embodiment, the threat information and policy management unit 150 can query the unique fingerprint characteristic information of the packet from previously detected results and return the results in a format such as STIX or JSON according to the threat information sharing (CTI) protocol (S702).

According to one embodiment, the security management unit 710 can block the site being accessed and block the execution of payloads downloaded from the site based on the response results in step S720 (S703).

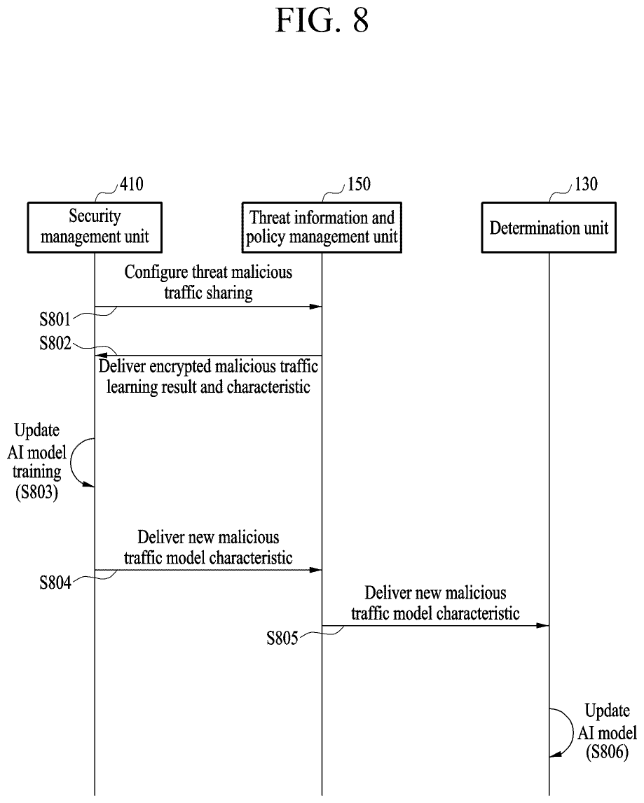

FIG. 8 is a flowchart illustrating a method for determining whether a malicious packet is included in conjunction with external cloud equipment and networks according to one embodiment.

Referring to FIG. 8, the security management unit 410 included in the external cloud equipment and network can be pre-configured to share threat traffic detection results with the threat information and policy management unit 150 (S801).

According to one embodiment, the threat information and policy management unit 150 can transmit the packet and characteristic information and results to the shared security management unit 410 when new learning results are generated (S802). The security management unit 410 can enhance its artificial intelligence learning model using the information (S803).

Additionally, for malicious encrypted traffic packets detected in external networks and clouds, the security management unit 410 can transmit extracted characteristics and learning results to the threat information and policy management unit 150 (S804).

According to one embodiment, the threat information and policy management unit 150 can transmit the received characteristics and learning results to the determination unit 130 in step S840 (S805). Based on the received characteristics and learning results, the determination unit 130 can reinforce the artificial neural network through reinforcement learning (S806).

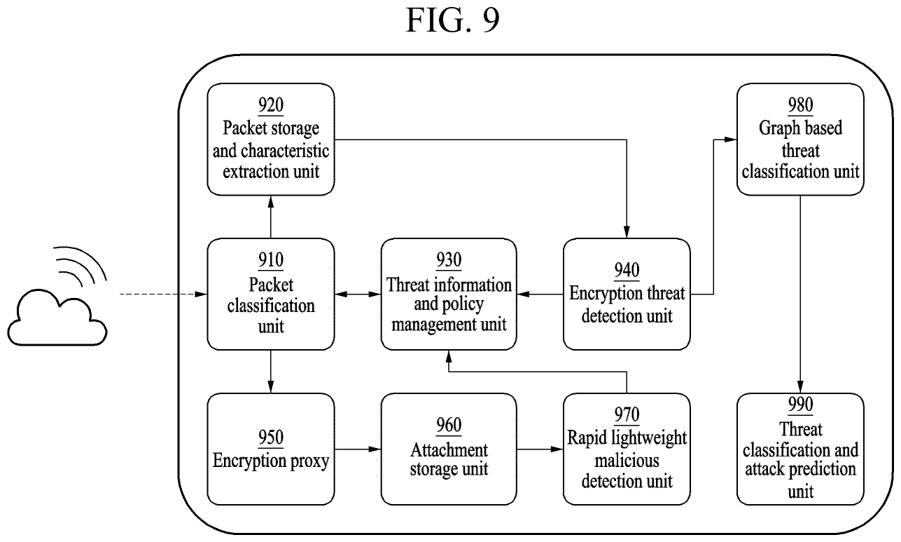

FIG. 9 is a block diagram illustrating an artificial intelligence-based network encryption threat detection and classification device according to one embodiment of the present invention.

Referring to FIG. 9, the artificial intelligence-based network encryption threat detection and classification device of the present invention can comprise a packet classification unit 910, a packet storage and characteristic extraction unit 920, a threat information and policy management unit 930, an encryption threat detection unit 940, an encryption proxy 950, an attachment storage unit 960, a rapid lightweight malicious detection unit 970, a graph-based threat classification unit 980, and a threat classification and attack prediction unit 990.

According to one embodiment, the packet classification unit 910 can classify and manage data packets transmitted through the network according to sessions. A session can mean a connection state maintained during a specific time or while performing a specific task in network communication.

That is, the packet classification unit 910 can classify packet traffic based on encryption protocols for network traffic incoming from environments such as the Internet, LAN, and virtual networks according to the protocol of the packets.

The packet classification unit 910 can analyze all network traffic in real-time to identify the session to which each packet belongs. For example, the packet classification unit 910 can classify packets based on header information of packets such as source and destination IP addresses, port numbers, and protocol types. Particularly, the packet classification unit 910 can classify packets into corresponding sessions according to specific users or devices, applications used, types of tasks performed, etc.

The packet classification unit 910 can transmit the classified packets to the packet storage and characteristic extraction unit 920 after classifying each packet by session.

The packet storage and characteristic extraction unit 920 can process network traffic in real-time or in a mirroring manner to store packets for each session. The packet storage and characteristic extraction unit 920 can extract fingerprint characteristics and generate meta characteristics that change over time.

Specifically, the packet storage and characteristic extraction unit 920 can capture the dynamic changes of packets occurring during the session duration to generate meta characteristics.

That is, the packet storage and characteristic extraction unit 920 can classify packets using fingerprint characteristics extractable from encrypted packet header information or traffic patterns. The packet storage and characteristic extraction unit 920 can combine additional meta characteristics based on the characteristics of the classified packets to generate detailed information. The generated meta information can comprise at least one of RTT (Round Trip Time), network latency, and the traffic pattern and connection time of the packet.

According to one embodiment, the packet storage and characteristic extraction unit 920 may store primary fingerprint characteristics and secondary meta characteristic information of session packets for characteristics where sufficient time and data to generate meta characteristics are not available.

The packet storage and characteristic extraction unit 920 may generate at least one of meta information such as RTT (total network round-trip time of the packet), network latency, transmission and reception patterns of traffic including the packet, BPS (Bit/s), PPS (Packet/s), connection time between packets (Connection/s), sessions (Sessions/s), user information (User/s) that can be estimated and extracted through associated information between traffic packet fingerprint information and response packets, and the estimated hit rate (Hits/s) of the packet's destination. The packet storage and characteristic extraction unit 920 may generate meta information by cross-combining source and destination information for the generated meta characteristics. Meta information may be information of a more extended concept generated based on meta characteristics. Meta information may be the result obtained by synthesizing or analyzing various meta characteristics. For example, meta information may include traffic flow analysis results of packets, security threat identification, and network capacity planning.

The threat information and policy management unit 930 may perform a function of specifically managing security policies. Specifically, the threat information and policy management unit 930 may manage the setting, modification, and deletion of security policies and adjust policies related to the operation of network traffic and various security equipment.

The packet storage and characteristic extraction unit 920 may transmit the extracted characteristics to the encryption threat detection unit 940.

The encryption threat detection unit 940 may identify malicious packets among encrypted packets using the fingerprint characteristics and meta characteristics received from the session-based packet storage and characteristic extraction unit 920. The encryption threat detection unit 940 may perform group classification based on the fingerprint characteristics and meta characteristics. That is, the encryption threat detection unit 940 may determine maliciousness based on the fingerprint characteristics and meta characteristics and subdivide and group threats based on the determination results.

According to one embodiment, the encryption threat detection unit 940 may preprocess the fingerprint characteristics and meta characteristics to fit the learning model. The encryption threat detection unit 940 may normalize the fingerprint characteristics and meta characteristics received through the preprocessing process and group them using a large-scale data classification model.

The encryption proxy 950 may process packets classified as malicious. The encryption proxy 950 may perform tasks related to the management of encrypted payloads. For example, the encryption proxy 950 may generate a pre-proxy procedure to decrypt the encrypted payload of a communication session. The encryption proxy 950 may combine sessions and transmit packets to the attachment storage unit 960. The attachment storage unit 960 may store packets of decrypted attachment files.

The packet classification unit 910 may transmit information about packets classified as malicious to the encryption proxy 950.

The attachment storage unit 960 may transmit files to the rapid lightweight malicious detection unit 970. The rapid lightweight malicious detection unit 970 may determine whether the transmitted attachment file is malicious and transmit the determination result to the threat information and policy management unit 930.

The threat information and policy management unit 930 may share results on malicious files in data formats such as STIX for threat information sharing (CTI) protocols and JSON. Additionally, the threat information and policy management unit 930 may communicate with terminals such as PCs to block malicious files when they are introduced.

The packet storage and characteristic extraction unit 920 may transmit the extracted characteristics to the encryption threat detection unit 940. The encryption threat detection unit 940 may identify malicious packets among encrypted packets using the fingerprint characteristics and meta characteristics received from the session-based packet storage and characteristic extraction unit 920.

The encryption threat detection unit 940 may transmit encrypted packet information to the graph-based threat classification unit 980. The graph-based threat classification unit 980 may assign the transmitted packet information to classification reference points of a graph. Specifically, the graph-based threat classification unit 980 may generate a graph by embedding nodes based on characteristics. Through this, the graph-based threat classification unit 980 may detect even characteristics relatively weak in robustness in encryption detection and provide the effect of improving classification capability. Additionally, the graph-based threat classification unit 980 may perform the role of secondarily verifying and classifying malicious threats.

The graph-based threat classification unit 980 may provide the classification results through a graph-based artificial intelligence model to the threat classification and attack prediction unit 990.

The threat classification and attack prediction unit 990 may determine an attack campaign suitable for the threat classification characteristics by pre-learning techniques and campaigns for each attack. For example, the threat classification and attack prediction unit 990 may identify an appropriate attack type by comparing it with previously determined data through Mitre attack type information and threat information CTI (Cyber Threat Intelligence).

Additionally, the threat classification and attack prediction unit 990 may analyze threat information and assign an attack campaign related to a specific graph node. Through this, the threat classification and attack prediction unit 990 may derive the correlation between the characteristics of classified threats and attack techniques.

Additionally, the threat classification and attack prediction unit 990 may predict the final attack technique based on the graph node analysis results. Through this, the threat classification and attack prediction unit 990 may predict the attack types and sequences that may occur subsequently. That is, the threat classification and attack prediction unit 990 may predict attacks that may occur following the classified threats.

The threat classification and attack prediction unit 990 may transmit the predicted results to external terminals or networks to prepare for potential future attacks in the network and terminal environment and provide a function to block them in advance if necessary.

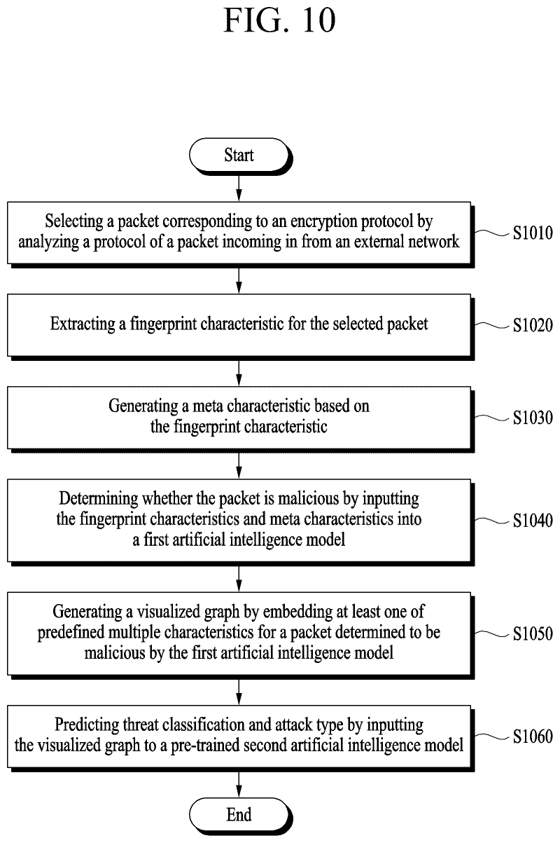

FIG. 10 is a flowchart illustrating a method for detecting and classifying network encryption threats based on artificial intelligence according to one embodiment of the present invention.

Referring to FIG. 10, the method for detecting and classifying network encryption threats based on artificial intelligence may comprise analyzing the protocol of a packet incoming from an external network to select a packet corresponding to an encryption protocol (S1010), extracting fingerprint characteristics for the selected packet (S1020), generating meta characteristics based on the fingerprint characteristics (S1030), determining maliciousness by inputting the fingerprint characteristics and meta characteristics into a first artificial intelligence model (S1040), generating a visualized graph by embedding one of predefined multiple characteristics for a packet determined to be malicious by the first artificial intelligence model (S1050), and performing threat classification and attack type prediction by inputting the visualized graph to a pre-trained second artificial intelligence model (S1060).

In step (S1010), the artificial intelligence-based network encryption threat detection and classification device may analyze the protocol of an incoming packet to select a packet corresponding to an encryption protocol. More specifically, the artificial intelligence-based network encryption threat detection and classification device may monitor traffic packets incoming to the network in real-time. The artificial intelligence-based network encryption threat detection and classification device may read the header information of each packet and analyze the protocol type and related fields.

In step S1010, the artificial intelligence-based network encryption threat detection and classification device can determine whether an encrypted session has started based on TLS/SSL handshake data. The artificial intelligence-based network encryption threat detection and classification device can exclude unencrypted packets (e.g., HTTP, FTP) and select only packets corresponding to encrypted traffic.

The artificial intelligence-based network encryption threat detection and classification device can organize and store the selected encrypted packets by session. The artificial intelligence-based network encryption threat detection and classification device can group packets belonging to the same encrypted session.

In step S1020, the artificial intelligence-based network encryption threat detection and classification device can extract fingerprint characteristics for the packets selected in step S1010. For example, the artificial intelligence-based network encryption threat detection and classification device can extract source IP, destination IP, source port, and destination port information from the IP header of the selected packets.

Fingerprint characteristics are unique and immutable information extracted from packets, which can represent the fundamental characteristics of network traffic. For example, fingerprint characteristics may comprise at least one of source IP, destination IP, port number, protocol information, and certificate characteristics. In step S1020, the artificial intelligence-based network encryption threat detection and classification device can generate unique fingerprint characteristics based on the detailed information of the network connection.

In step S1030, the artificial intelligence-based network encryption threat detection and classification device can generate meta characteristics based on the fingerprint characteristics extracted in step S1020. The artificial intelligence-based network encryption threat detection and classification device can generate meta characteristics, which are high-dimensional characteristics reflecting temporal changes and describing dynamic traffic behavior, based on the fingerprint characteristics. For example, meta characteristics may comprise at least one of RTT (Round Trip Time), network latency, transmission and reception patterns (BPS, PPS), and connection time between packets (Connection/s).

In step S1040, the artificial intelligence-based network encryption threat detection and classification device can determine whether the target packet is malicious by inputting the fingerprint characteristics extracted in step S1020 and the meta characteristics generated in step S1030 into a first artificial intelligence model.

For example, the first artificial intelligence model may be an artificial neural network based on neural network models of the RNN or CNN series. The first artificial intelligence model may comprise hyperparameter optimization and an ensemble learning structure.

According to one embodiment, the input data of the first artificial intelligence model may be data combining fingerprint characteristics and meta characteristics. That is, the first artificial intelligence model may be an artificial neural network model that combines and learns fingerprint and meta characteristics based on deep learning models such as RNN and CNN and outputs results determining maliciousness based on the requested characteristics.

In step S1050, the artificial intelligence-based network encryption threat detection and classification device can generate a visualized graph by embedding one of multiple characteristics for the packet determined to be malicious by the first artificial intelligence model in step S1040.

Embedding refers to representing high-dimensional data in a low-dimensional vector space and may comprise an operation of generating a vector corresponding to the characteristics of the packet. More specifically, the embedded vectors may be represented as points on a graph.

The predefined multiple characteristics may comprise a first characteristic indicating transaction information of a packet corresponding to the encryption protocol, a second characteristic indicating session information to which a packet corresponding to the encryption protocol is transmitted or received, and a third characteristic indicating IP information to which a packet corresponding to the encryption protocol is transmitted.

According to one embodiment, the visualized graph associated with the first characteristic may comprise a first graph indicating a packet determined to be malicious as one point based on a class of the transaction information. More specifically, the visualized graph based on transaction information may generally be a graph in which each transaction is represented as one point within the graph.

More specifically, the first graph may be a graph visualizing a packet determined to be malicious as one point on the graph based on transaction unit data. Each point may be arranged based on the main characteristics of the corresponding transaction (e.g., attack type, traffic pattern, RTT, etc.). The X-axis and Y-axis included in the first graph may be set to correspond to two main elements among the transaction characteristics. The color or shape of each point included in the first graph may indicate the classification result of the transaction.

For example, transactions may be classified as normal or malicious, and transactions determined to be malicious may be further classified into one of the subdivided attack types. That is, the artificial intelligence-based network encryption threat detection and classification device can visualize not only whether the transaction is normal or malicious but also classify and visualize malicious transactions according to the attack type.

Additionally, the artificial intelligence-based network encryption threat detection and classification device can perform an operation to remove noise generated due to errors in the classification model in advance. Through this, the generated graph can display only accurate data.

According to another embodiment, the visualized graph associated with the second characteristic may comprise a second graph representing each session as a point having visually different characteristics according to a data type corresponding to each session.

Specifically, the second graph may be a graph visualizing each session's data by data type through graph artificial intelligence-based analysis. For example, the artificial intelligence-based network encryption threat detection and classification device can analyze session data and classify it into five major attack types: DDOS, CSRF, phishing, data leakage, and malware transmission. The artificial intelligence-based network encryption threat detection and classification device can classify session data according to normal data and the five major attack types.

More specifically, the artificial intelligence-based network encryption threat detection and classification device can learn the relationships and patterns between sessions using a Graph Neural Network (GNN)-based approach. The artificial intelligence-based network encryption threat detection and classification device can simplify complex data types through the embedding process of the GNN. Additionally, the artificial intelligence-based network encryption threat detection and classification device can reconstruct characteristics to suit the analysis purpose.

For example, the color, shape, size, etc., of the points included in the second graph may indicate the type of session data and the classified attack type. The X-axis and Y-axis included in the second graph may be set based on the main characteristics of the session data.

According to another embodiment, the visualized graph associated with the third characteristic may be a third graph displaying an IP address corresponding to each IP information as one point and displaying the connection state of points corresponding to each based on a connection state between IP addresses.

By way of example, the third graph may be a graph visually representing the traffic connection state based on the pair between the source IP and the destination IP. Specifically, the points included in the third graph may be represented based on each IP address. The third graph may indicate the traffic relationship between the source IP and the destination IP based on the connection state of each point. The thickness or color of each connection line may represent the intensity of traffic or the amount of data transmission.

In step S1060, the artificial intelligence-based network encryption threat detection and classification device may input the visualized graph from step S1050 into a pre-trained second artificial intelligence model to perform threat classification and attack type prediction.

Specifically, the second artificial intelligence model may output the result of predicting threat classification and attack type by taking at least one of the point information included in the graph, the connection information of the points, or the structural pattern of the entire graph as input. The second artificial intelligence model may be based on deep learning techniques such as a Graph Neural Network (GNN), Graph Convolutional Network (GCN), or Graph Attention Network (GAT).

By way of example, in step S1060, the artificial intelligence-based network encryption threat detection and classification device may cluster the points included in the graph, learn from them, and provide classification results based on clustering.

According to one embodiment, in step S1060, the artificial intelligence-based network encryption threat detection and classification device may perform clustering for at least one point included in the visualized graph, determine a representative instance for each cluster based on the clustering result, and determine the attack type for the cluster based on the attack campaign corresponding to the representative instance.

By way of example, the representative instance may mean a representative data point. The representative data point may be the data point closest to the center (centroid) of each cluster.

According to another embodiment, the representative data point may be the data point with the minimum sum of distances to all other points within the cluster or a data point reflecting statistical characteristics such as the average or mode of the data points within the cluster.

The artificial intelligence-based network encryption threat detection and classification device may identify threats based on the representative data point, thereby reducing the need to analyze all data within the cluster individually and improving analysis efficiency. That is, by analyzing only the representative instance instead of the entire data, the time and resources required for analysis can be reduced. Additionally, this allows for the rapid identification of attack types based on the representative instance, enabling the quick establishment of appropriate response strategies.

According to another embodiment, the artificial intelligence-based network encryption threat detection and classification device may analyze the relationships and sequences between attack types based on graph data. The second artificial intelligence model may output the result of determining which attack campaign the current threat belongs to by utilizing pre-trained attack campaign data (e.g., attack patterns, sequential attack scenarios). By way of example, subsequent attacks may be predicted based on the same attacker's IP address pattern or similar traffic characteristics.

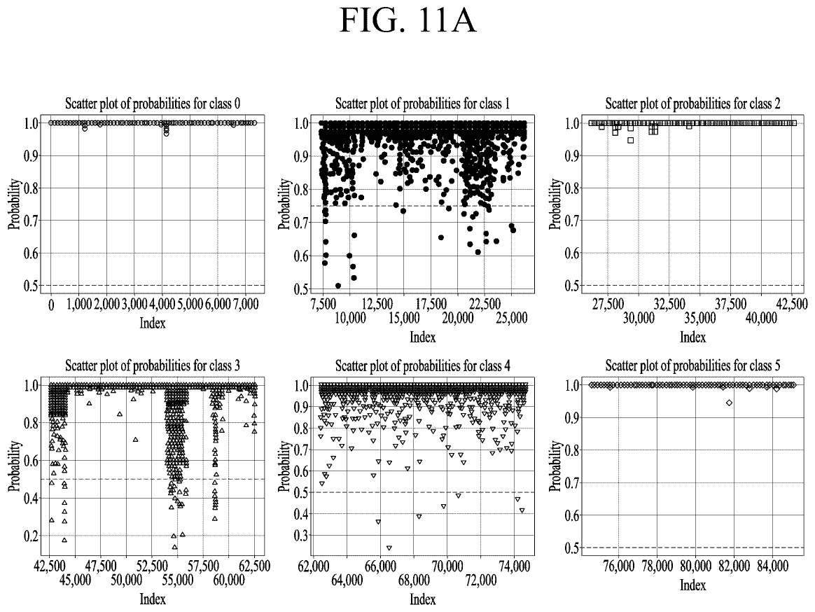

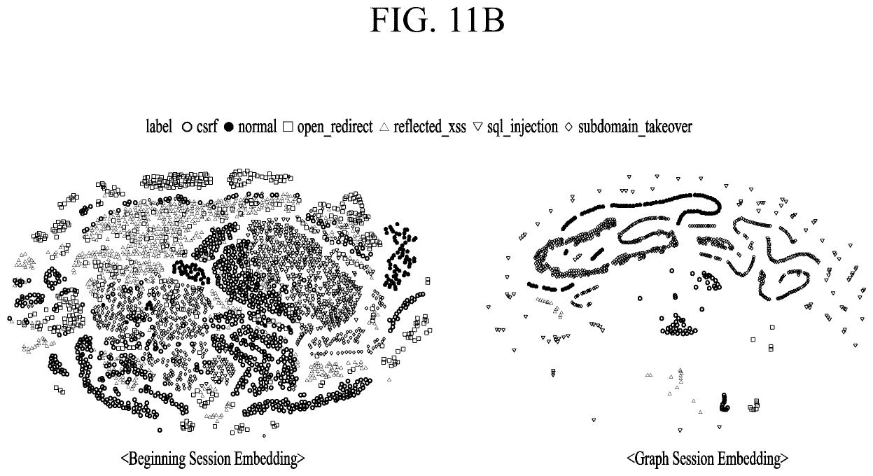

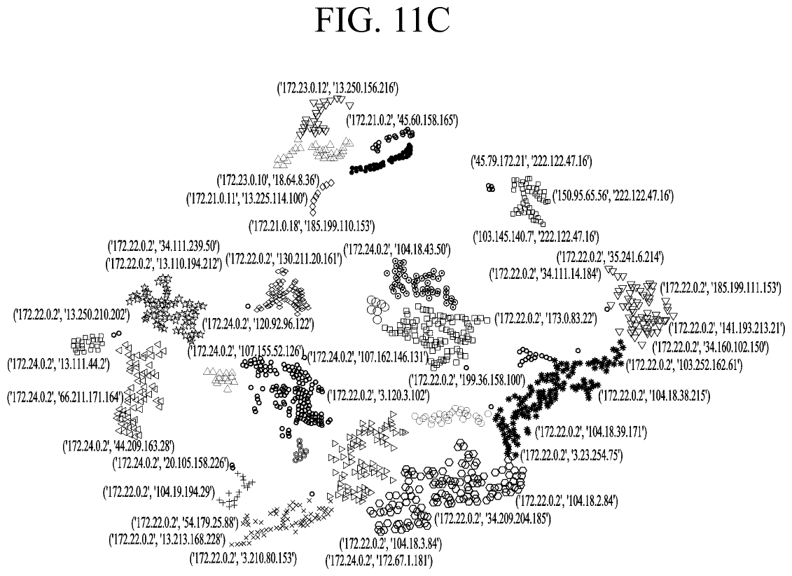

FIGS. 11A to 11C are exemplary diagrams for explaining graphs generated based on characteristics according to one embodiment of the present invention.

FIG. 11A may be an exemplary diagram showing the result of determining whether a transaction belongs to a specific class by representing the transaction as a single point.

Referring to FIG. 11A, a graph associated with the first characteristic is shown. The first characteristic may indicate transaction information of a packet corresponding to the encryption protocol. In the graph associated with the first characteristic, the points may be defined as packets determined to be malicious based on the class of the transaction information.

The artificial intelligence-based network encryption threat detection and classification device may set the x-axis included in the graph associated with the first characteristic as the index of the data points. The y-axis included in the graph associated with the first characteristic may be the probability that the corresponding data point belongs to a specific class. Through this, the artificial intelligence-based network encryption threat detection and classification device may investigate which type of transaction is transmitted or received through which port and pre-select classes with a high risk of attack.

FIG. 11B may be an exemplary diagram showing a graph in which each session is labeled according to its type and embedded as a point.

By way of example, the method of labeling sessions may include distinguishing between normal traffic (Normal) and malicious traffic (Malicious), labeling based on the network protocol used in the session, labeling based on the characteristics of the traffic included in the session, or labeling based on the characteristics of the attack. Accordingly, the artificial intelligence-based network encryption threat detection and classification device may analyze patterns by session type.

Referring to FIG. 11B, applying graph artificial intelligence-based embedding may allow session data to be more clearly clustered by type. Specifically, the artificial intelligence-based network encryption threat detection and classification device may visually represent and provide that each type, such as CSRF, Open Redirect, SQL Injection, Reflected XSS, etc., forms an independent area on the graph. That is, the artificial intelligence-based network encryption threat detection and classification device may learn the structural relationships between sessions and provide information about the characteristics of each attack type.

Through this, the artificial intelligence-based network encryption threat detection and classification device may quickly detect threats by utilizing data clustered by session type.

FIG. 11C may be an exemplary diagram visually representing IP and labeled session data. More specifically, the artificial intelligence-based network encryption threat detection and classification device may provide a prediction result in advance for IPs with similar attack patterns based on FIG. 11C.

Referring to FIG. 11C, the points included in the graph may represent IP addresses or session data. The IP address may mean the source or destination of network traffic, and each session data may represent the traffic relationship between the corresponding IPs.

Referring to FIG. 11C, the points grouped with the same color on the graph may represent IPs and session data sharing similar attack patterns. The artificial intelligence-based network encryption threat detection and classification device may perform clustering based on artificial intelligence. That is, the artificial intelligence-based network encryption threat detection and classification device may group nodes with similar traffic characteristics.

The artificial intelligence-based network encryption threat detection and classification device may determine that IPs within the same cluster are likely to have similar attack patterns. Through this, the artificial intelligence-based network encryption threat detection and classification device may predict potential attacks.

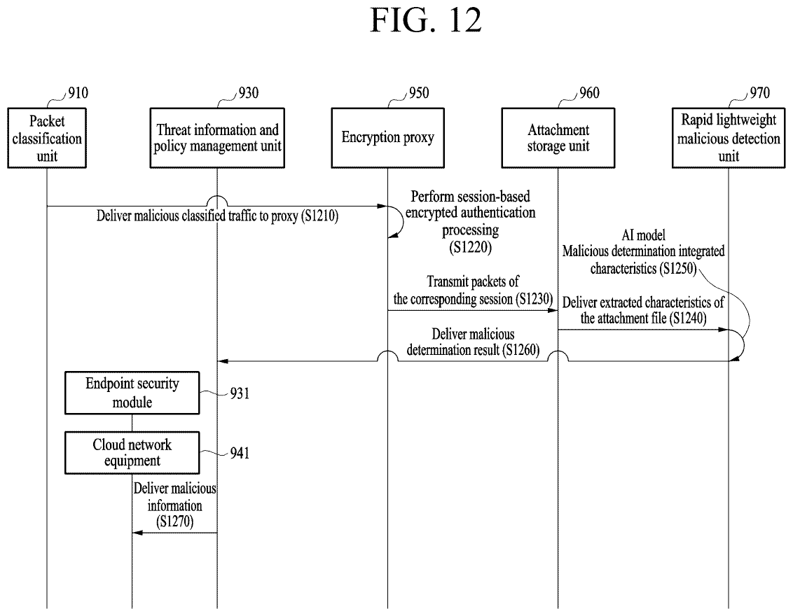

FIG. 12 is a flowchart for explaining an operation of detecting a malicious attachment file included in an encryption threat according to an embodiment of the present invention.

Referring to FIG. 12, the packet classification unit 910 may transmit packet information to the encryption proxy 950 to distinguish and block detailed malicious determination and threats of payloads and attachment files included in the target packet (S1210).

The encryption proxy 950 may extract the encrypted payload through encryption authentication (S1220).

The encryption proxy 950 may transmit the target packet to the attachment storage unit 960 for storing the payload and attachment files attached to the session from the combination of the transmitted packets (S1230).

The attachment storage unit 960 may extract and combine the payload from the session, store all attached files, and transmit them to the lightweight malicious detection unit 970 (S1240).

The lightweight malicious detection unit 970 may classify and detect malicious files based on information integrating static or dynamic characteristics extracted from malicious code, a learned artificial intelligence-based detection model, or malicious information existing in the blacklist hash of previously detected malicious files and cyber threat information (S1250).

The lightweight malicious detection unit 970 may transmit the malicious determination result to the threat information and policy management unit 930 (S1260). The threat information and policy management unit 930 may transmit a security policy reflecting the malicious determination result to the endpoint security module 931 and the cloud network equipment 941 (S1270).

The artificial intelligence-based network encryption threat detection and classification device may be mounted on various security equipment and network equipment such as firewalls (FW), UTM, intrusion prevention systems (IPS), and next-generation network detection (NDR). The endpoint security module 931 operating on various terminal devices such as external PCs, mobile devices, and IoT devices may provide malicious detection information for site access information.

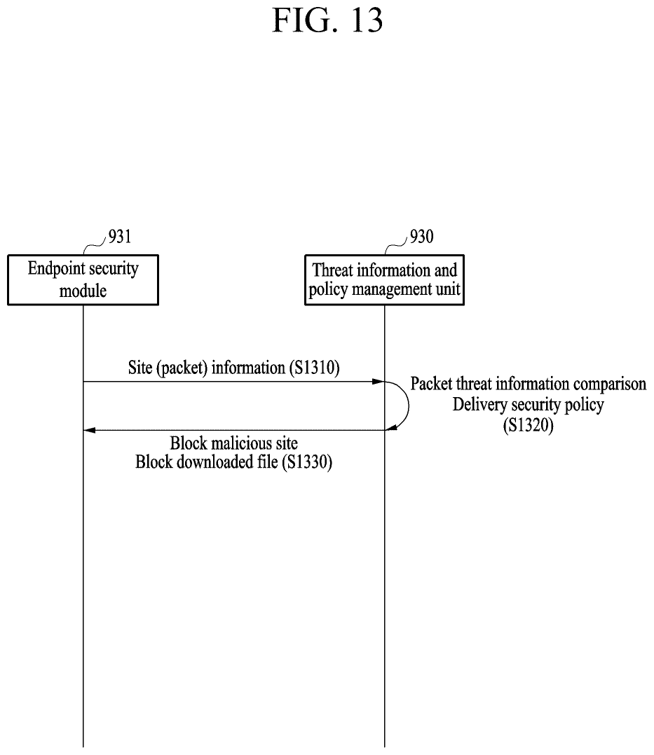

FIG. 13 is a flowchart for explaining an operation of the artificial intelligence-based network encryption threat detection and classification device interacting with an endpoint according to an embodiment of the present invention.

Referring to FIG. 13, the endpoint security module 931 may transmit site information packets or packet information including specific fingerprint characteristics accessed by the terminal device to the threat information and policy management unit 930 (S1310).

According to one embodiment, the threat information and policy management unit 930 may query the unique fingerprint characteristic information of the packet from previously detected results and reply to the result in a format such as STIX or JSON according to the threat information sharing (CTI) protocol (S1320).

According to one embodiment, the endpoint security module 931 may block the site being accessed and block the execution of payloads downloaded from the site based on the result replied in step (S1320) (S1330).

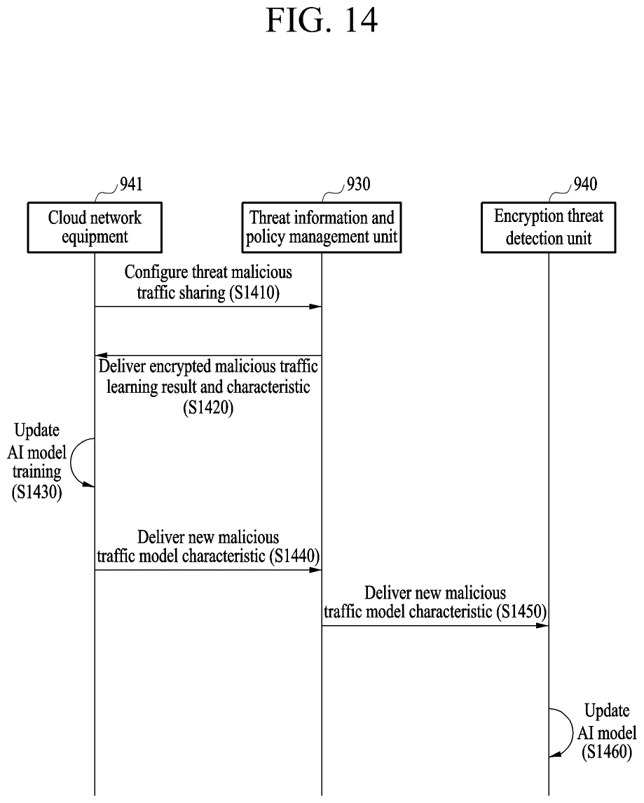

FIG. 14 is a flowchart for explaining an operation of the artificial intelligence-based network encryption threat detection and classification device interacting with the cloud according to an embodiment of the present invention.

Referring to FIG. 14, the cloud network equipment 941 may be pre-configured to share threat traffic detection results with the threat information and policy management unit 930 (S1410).

According to one embodiment, the threat information and policy management unit 930 may transmit packet and characteristic information and detection results to the cloud network equipment 941 when new learning results are generated (S1420).

The cloud network equipment 941 may enhance its artificial intelligence learning model through the transmitted packet and characteristic information and detection results (S1430).

Additionally, for malicious encrypted traffic packets detected in external networks and the cloud, the cloud network equipment 941 may transmit extracted characteristics and learning results to the threat information and policy management unit 930 (S1440).

According to one embodiment, the threat information and policy management unit 930 may transmit the characteristics and learning results received in step (S1440) to the encryption threat detection unit 940 (S1450).

Based on the received characteristics and learning results, the encryption threat detection unit 940 may reinforce the artificial neural network through reinforcement learning (S1460).

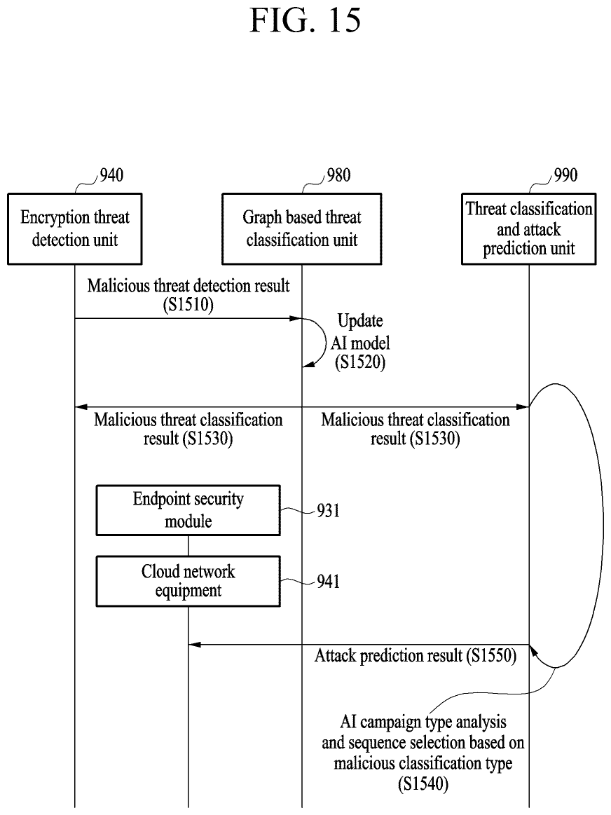

FIG. 15 is a flowchart for explaining an operation of detecting, classifying, and predicting encryption threats according to an embodiment of the present invention.

Referring to FIG. 15, the encryption threat detection unit 940 may transmit the detected malicious traffic and threat information to the graph-based threat classification unit 980 (S1510). The detected threats may be results generated based on fingerprint characteristics and meta characteristics collected in the previous step.

The graph-based threat classification unit 980 may update the artificial intelligence model using newly learned patterns and data to continuously improve detection and prediction accuracy (S1520).

The graph-based threat classification unit 980 may classify the transmitted malicious traffic data into threat types using the second artificial intelligence model. For example, each threat may be visualized and classified as a cluster or individual node with the same characteristics through graph-based classification.

The graph-based threat classification unit 980 may transmit the classification results to the encryption threat detection unit 940 and the threat classification and attack prediction unit 990 (S1530).

The threat classification and attack prediction unit 990 may analyze whether the detected threat belongs to a specific attack campaign using the artificial intelligence model. The threat classification and attack prediction unit 990 may predict attack sequences according to the campaign type (S1540).

For example, the threat classification and attack prediction unit 990 may predict potential attacks based on the determined attack type.

The threat classification and attack prediction unit 190 may deliver the derived results to the endpoint security module 931 and the cloud network equipment 941 (S1550). The prediction results may be utilized for real-time security policy updates and blocking potential attacks.

The threat classification and attack prediction unit 990 may provide information to enable the endpoint security module 931 and the cloud network equipment 941 to perform operations to block potential attacks.

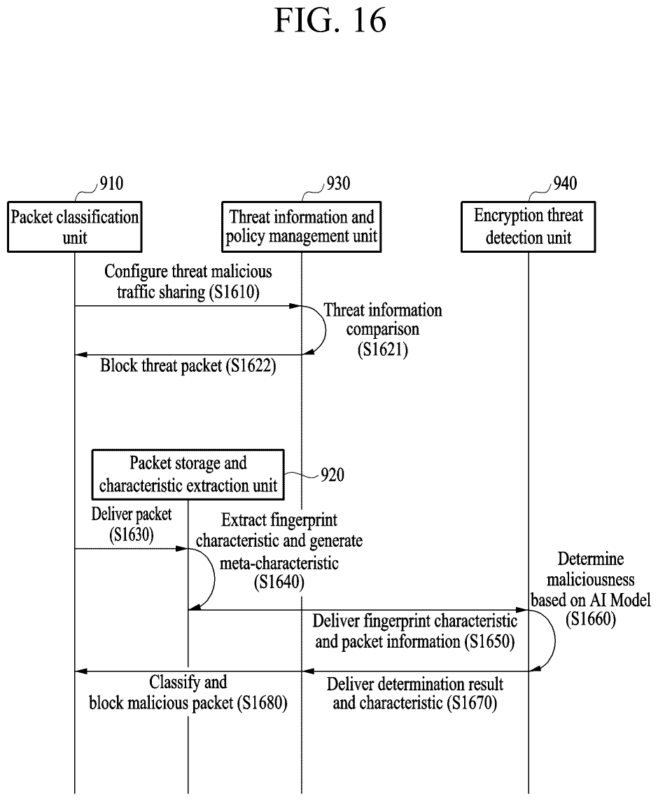

FIG. 16 is a flowchart illustrating the operation of encryption threat detection according to an embodiment of the present invention.

According to one embodiment, the packet classification unit 910 classifies the protocol from incoming network traffic packets and transmits packets corresponding to the secure channel to the packet storage and characteristic extraction unit 920. The classified packets may be used for subsequent auditing and alert processing, and may be stored for asynchronous mirroring configurations depending on the network configuration.

Referring to FIG. 16, the packet classification unit 910 may request the threat information and policy management unit 930 to determine maliciousness quickly for packets already detected as malicious in advance (S1610). If there is a malicious detection result for the same packet through the threat information and policy management unit 930, the corresponding packet may be blocked (S1621).

That is, the threat information and policy management unit 930 may block the packet without additional analysis by comparing it with pre-stored threat information when the packet is incoming (S1622). Since the meta characteristics depend on immutable information (source, destination IP address and port, security information, etc.) in the fingerprint characteristics, the artificial intelligence-based network encryption threat detection and classification device can identify the packet through the fingerprint characteristics and block the corresponding packet immediately if there is existing detection determination information.

In another embodiment, if the target packet is not a previously detected packet, the packet classification unit 910 may transmit the target packet information to the packet storage and characteristic extraction unit 920 (S1630).

The packet storage and characteristic extraction unit 920 may extract characteristics corresponding to fingerprint characteristics from the packet (S1640). The characteristics corresponding to the fingerprint characteristics may include basic source, destination IP address and port, as well as types of encryption protocols essential for forming a secure channel, encryption strength, certificate information, and request agent information, among others, and may include information contained in the header. The fingerprint characteristics are predefined and may be individually extracted for each requested packet.

The packet storage and characteristic extraction unit 920 may extract fingerprint characteristics and advanced meta characteristics (S1640). The packet storage and characteristic extraction unit 920 may check whether there are associated packets previously stored based on the requested packet and its characteristics.

According to another embodiment, if there are no associated packets and characteristics related to the target packet, the packet storage and characteristic extraction unit 920 may store the target packet and its characteristics again in the packet characteristics of the corresponding session. The packet storage and characteristic extraction unit 920 may reply to the threat information and policy management unit 930 with a non-detection result indicating that additional characteristic information is required for the target packet.

According to one embodiment, the meta characteristics may include RTT (total network round-trip time of the packet), network latency, transmission and reception patterns of traffic containing the target packet, BPS (Bit/s), PPS (Packet/s), connection time between packets (Connection/s), sessions (Sessions/s), user information (User/s) inferred and extracted through associated information between traffic packet fingerprint information and response packets, and the estimated hit rate (Hits/s) of the packet's purpose. The artificial intelligence-based network encryption threat detection and classification device may generate various final meta characteristics by cross-combining the source and destination information for the generated characteristics.

The packet storage and characteristic extraction unit 920 may accumulate and store multiple packet data. The artificial intelligence-based network encryption threat detection and classification device may not only query a single packet but also query accumulated multiple packet data at once, providing results of analyzing the overall context and patterns of traffic.

Additionally, the artificial intelligence-based network encryption threat detection and classification device may extract and calculate interrelated information from accumulated packet information to combine and generate advanced characteristics.

The packet storage and characteristic extraction unit 920 may transmit the fingerprint characteristics and the generated meta characteristics to the encryption threat detection unit 940 (S1650).

The encryption threat detection unit 940 may generate and reference classification indicators clustered into a large-scale classification model without labeling, based on pre-collected and labeled large-scale general and malicious traffic packet data and fingerprint characteristics.

The encryption threat detection unit 940 may analyze the fingerprint and meta characteristics through an optimized ensemble learning model based on deep learning models (RNN, CNN) to generate determination results (S1660). The encryption threat detection unit 940 may transmit the determination results and characteristics to the threat information and policy management unit 930 (S1670).

The threat information and policy management unit 930 may receive and store the determination results transmitted from the encryption threat detection unit 940 and provide the corresponding information externally.

The threat information and policy management unit 930 may transmit the final results to the packet classification unit 910 (S1680). The packet classification unit 910 may block the packet based on the detection result of the target packet (synchronous) or transmit and store the results in security systems, databases, etc., for queries and logs of stored packets (asynchronous).

According to the embodiments of the present invention described above, it is possible to detect malicious threats in encrypted traffic without separate decryption equipment, significantly reducing resource and time consumption caused by network traffic decryption. Additionally, after quickly detecting malicious threats, the threat types can be classified through AI-based analysis to predict potential attack types that may occur in the future and respond preemptively.

In this specification, preferred embodiments of the present invention have been disclosed, and although specific terms have been used, they are used in a general sense to easily explain the technical content of the present invention and to aid understanding of the invention, and are not intended to limit the scope of the present invention. In addition to the disclosed embodiments, other modifications based on the technical spirit of the present invention can be implemented, which will be apparent to those skilled in the art to which the present invention pertains. For example, those skilled in the art will understand that the method for determining whether a malicious packet is included in encrypted traffic based on artificial intelligence according to the embodiments described with reference to FIGS. 1 to 8 can be variously modified. Therefore, the scope of the invention should not be determined by the described embodiments but should be determined by the technical spirit described in the claims.

What is claimed is:

1. A method for detecting and classifying network encryption threats based on artificial intelligence performed by a computing device, comprising:
selecting a packet corresponding to an encryption protocol by analyzing a protocol of a packet incoming in from an external network;
extracting a fingerprint characteristic for the selected packet;
generating a meta characteristic based on the fingerprint characteristic;
determining maliciousness by inputting the fingerprint characteristic and meta characteristic into a first artificial intelligence model;
generating a visualized graph by embedding at least one of predefined multiple characteristics together for a packet determined to be malicious by the first artificial intelligence model; and
performing threat classification and attack type prediction by inputting the visualized graph to a pre-trained second artificial intelligence model.

2. The method for detecting and classifying network encryption threats according to claim 1, wherein the predefined multiple characteristics comprise:
a first characteristic indicating transaction information of a packet corresponding to the encryption protocol;
a second characteristic indicating session information to which a packet corresponding to the encryption protocol is transmitted or received; and
a third characteristic indicating IP information to which a packet corresponding to the encryption protocol is transmitted.

3. The method for detecting and classifying network encryption threats according to claim 2,
wherein the visualized graph associated with the first characteristic comprises a first graph indicating a packet determined to be malicious as one point based on a class of the transaction information,
wherein the visualized graph associated with the second characteristic comprises a second graph representing each session as a point having visually different characteristics according to a data type corresponding to each session, and
wherein the visualized graph associated with the third characteristic comprises a third graph displaying an IP address corresponding to each IP information as one point, and displaying a connection state of points corresponding to each based on a connection state between IP addresses.

4. The method for detecting and classifying network encryption threats according to claim 3, wherein the performing threat classification and attack type prediction comprises:
performing clustering for at least one point included in the visualized graph;
determining a representative instance for each cluster based on the clustering result; and
determining an attack type for the cluster based on an attack campaign corresponding to the representative instance.

5. The method for detecting and classifying network encryption threats according to claim 4, wherein the determining an attack type comprises:
predicting a potential attack based on the determined attack type; and
generating a signal to block the predicted potential attack.
